(19) United States
(12) Patent Application Publication
(10) Pub. No.: US 2026/0062551 A1
(43) Pub. Date: Mar. 5, 2026

(54) BIODEGRADABLE PLASTIC FORMULATIONS AND ANIMAL CHEWS PREPARED FROM THE SAME

(71) Applicant: Titan Bioplastics, LLC, Sammamish, WA (US)

(72) Inventors: David Allen Abecassis, Huntington Station, NY (US); Tanya Hart, Burien, WA (US); Ryan Nelson, Grand Rapids, MI (US)

(21) Appl. No.: 19/105,615

(22) PCT Filed: Aug. 22, 2023
(86) PCT No.: PCT/US2023/072679

§ 371 Date: Feb. 21, 2025

Related U.S. Application Data
(60) Provisional application No. 63/399,941, filed on Aug. 22, 2022.

(51) Int. Cl. C08L 67/04; A01K 15/02; A23K 20/105; A23K 50/42; C08K 3/30; C08K 3/34; C08K 3/38; C08K 9/12; C08L 1/12; C08L 89/00; C08L 89/04

(52) U.S. Cl. CPC C08L 67/04; A01K 15/026; A23K 20/105; A23K 50/42; C08K 3/30; C08K 3/346; C08K 3/38; C08K 9/12; C08L 1/12; C08L 89/00; C08L 89/04; C08K 2003/3045; C08L 2201/06; C08L 2203/30; C08L 2205/06; C08L 2312/00

(57) ABSTRACT

Recyclable and biodegradable and/or industrially compostable plastic formulations that include a recyclable and biodegradable thermoplastic polymer, a recyclable and biodegradable filler, and halloysite are provided. Also provided are articles of manufacture produced using the recyclable and biodegradable and/or compostable plastic formulations. In particular, super chewer toys, e.g. dog bones, made of a recyclable and biodegradable and/or industrially compostable plastic formulation are described.

### CROSS-REFERENCE TO RELATED APPLICATIONS

This application claims the benefit of U.S. Provisional Application 63/399,941, filed Aug. 22, 2022, which is incorporated by reference herein in its entirety.

### TECHNICAL FIELD

This disclosure relates to enhanced recyclable and industrially compostable plant-based materials and bioplastic formulations. The plant-based materials and bioplastic formulations disclosed herein may be used for a variety of applications, including for the manufacture of animal toys, e.g. a dog bone.

### BACKGROUND

A variety of pet toys, for example animal chew toys, made from thermoplastic are readily available to consumers and are a mainstay of pet owners everywhere. These products are typically formed by injection molding of petroleum-derived thermoplastics, which are often selected for their desirable mechanical properties and low cost. Unfortunately, virtually all of these products ultimately end up as landfill plastic waste, thereby contributing to plastic pollution and the growing environmental crisis. There is, therefore, a need to develop environmentally friendly, recyclable, and biodegradable plastic formulations that are safe for pets, viable in standard recycling methods, and useful in the manufacture of pet toys. In particular, such formulations are attractive because of their enhanced recyclability that provides a beneficial circularity to the material's end of life.

### SUMMARY

In a first aspect, the present disclosure relates to a recyclable and biodegradable plastic formulation composed of a recyclable and biodegradable thermoplastic polymer in combination with one or more recyclable and biodegradable fillers and halloysite.

In some embodiments, the recyclable and biodegradable thermoplastic polymer is present in the formulation at a concentration of about 40% by weight to about 98% by weight.

In some embodiments, the one or more recyclable and biodegradable fillers are present in the formulation at a concentration of about 1% by weight to about 50% by weight.

In some embodiments, the halloysite is present in the formulation at a concentration of about 1% by weight to about 10% by weight.

In some embodiment, the recyclable and biodegradable thermoplastic polymer, demonstrates high cold impact, high ductility and a high or low modulus of elasticity.

In some embodiments, the recyclable and biodegradable thermoplastic polymer includes polylactic acid and an acrylic cross-linker. In some embodiments, the recyclable and biodegradable thermoplastic polymer includes cellulose acetate and a biocompatible plasticizer. In some embodiments, the recyclable and biodegradable thermoplastic polymer includes one or more polyhydroxyalkanoates (PHA).

In some embodiments, the recyclable and biodegradable filler includes dried pulverized animal cartilage and chitosan, a non cellulose additive and base material for biopolymers. In some embodiments, the recyclable and biodegradable filler includes dried pulverized animal cartilage. In some embodiments, the recyclable and biodegradable filler includes chitosan, a non-cellulose additive and base material for biopolymers. In some embodiments, the recyclable and biodegradable filler includes milk-whey-protein-derived polymer.

In some embodiments, the recyclable and biodegradable plastic formulation also includes one or more micronutrients. For example, in some embodiments, the one or more micronutrients include lauryl phosphate. In some embodiments, the one or more micronutrients include urea.

In some embodiments, the recyclable and biodegradable plastic formulation additionally includes a recyclable and biodegradable scent that makes the formulation more attractive to pets. In some embodiments, the recyclable and biodegradable formulation is coated with the recyclable and biodegradable scent. In some embodiments, the recyclable and biodegradable formulation is compounded with one or more naturally derived terpenes and hypoallergenic scents/flavoring throughout the toy, rather than being used to coat the formulation. In some embodiments, the recyclable and biodegradable scent is combined with halloysite, such that the scent is time-released.

The recyclable and biodegradable plastic formulations are compatible with a variety of manufacturing processes. For example, in some embodiments, the recyclable and biodegradable plastic formulations are compatible with injection molding manufacturing processes.

Durability is an important feature to consider when selecting materials for pet toys, such as animal chew toys. The recyclable and biodegradable plastic formulations disclosed herein are highly durable. For example, in some embodiments, the recyclable and biodegradable plastic formulations demonstrate a wide range of Shore D hardness values of about 40 A to about 78 D, when measured via durometer. In some embodiments, the recyclable and biodegradable plastic formulations show high cold impact, high ductility, as well as a high or low modulus of elasticity.

In some embodiments, the recyclable and biodegradable plastic formulations of the disclosure are compostable under industrial conditions, for example, at elevated temperatures and/or in the presence of forced air. In some embodiments, the recyclable and biodegradable plastic formulations of the disclosure can be degraded and/or industrially composted within a period of about 90 days.

In a second aspect, the present disclosure relates to an animal super chewer toy comprising a single homogenous recyclable and biodegradable material, wherein the recyclable and biodegradable material is a thermoplastic and wherein the recyclable and biodegradable material is compatible with injection molding. In some embodiments, the super chewer toy is in the form of a dog bone.

In some embodiments, the single homogenous recyclable and biodegradable material used to produce the super chewer toy of the disclosure includes polylactic acid in combination with an acrylic cross-linker.

In some embodiments, the single homogenous recyclable and biodegradable material used to produce the super chewer toy of the disclosure includes cellulose acetate and a biocompatible plasticizer.

In some embodiments, the single homogenous recyclable and biodegradable material used to produce the super chewer toy of the disclosure includes a filler. In some embodiments, the filler is dried pulverized animal cartilage and/or chitosan, a non cellulose additive and base material for biopolymers. In some embodiments, the recyclable and biodegradable filler includes dried pulverized animal cartilage. In some embodiments, the recyclable and biodegradable filler includes chitosan. In some embodiments, the filler is a milk-whey-protein-derived polymer.

In some embodiments, the single homogenous recyclable and biodegradable material used to produce the super chewer toy of the disclosure includes halloysite. Without being bound to theory, the inclusion of halloysite in the material enhances recyclability.

In some embodiments, the single homogenous recyclable and biodegradable material used to produce the super chewer toy of the disclosure includes one or more polyhydroxyalkanoates (PHA). In some embodiments, the single homogenous recyclable and biodegradable material used to produce the super chewer toy of the disclosure includes calcium sulfate. In some embodiments, the single homogenous recyclable and biodegradable material used to produce the super chewer toy of the disclosure includes boric acid. In some embodiments, the single homogenous recyclable and biodegradable material used to produce the super chewer toy of the disclosure includes one or more polyhydroxyalkanoates, calcium sulfate, and boric acid.

In some embodiments, the single homogenous recyclable and biodegradable material used to produce the super chewer toy of the disclosure includes one or more micronutrients. For example, in some embodiments, the one or more micronutrients include lauryl phosphate. In some embodiments, the one or more micronutrients include urea.

In some embodiments, the super chewer toy of the disclosure include a recyclable and biodegradable scent that makes the super chewer toy more attractive to pets. In some embodiments, the biodegradable scent is combined with a carrier. In some embodiments, the carrier includes dispersed halloysite, such that the scent is time-released. In some embodiments, the biodegradable and recyclable scent is adsorbed upon halloysite and incorporated throughout the super chewer toy by compounding the halloysite with the adsorbed scent into the material used to manufacture the super chewer toy.

In some embodiments, the super chewer toy of the disclosure includes a central cavity. In some embodiments, this central cavity is tubular shaped. In some embodiments, the tubular-shaped central cavity has a diameter that is about 1% to about 10% the width of the super chewer toy. In some embodiments, a recyclable and biodegradable scent is disposed within the central cavity of the animal chew.

In some embodiments, the animal chew is formed by injection molding the single homogenous recyclable and biodegradable material into an appropriate shape, for example, in the form of a dog bone.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The present disclosure relates in a first aspect to a recyclable and biodegradable plastic formulation that includes a recyclable and biodegradable thermoplastic polymer, a biodegradable filler, and halloysite.

In some embodiments, the recyclable and biodegradable thermoplastic polymer is present in the formulation at a concentration of about 40% by weight to about 98% by weight. For example, in some embodiments, the recyclable and biodegradable thermoplastic polymer is present in the formulation at a concentration of about 40% by weight, about 45% by weight, about 50% by weight, about 55% by weight, about 60% by weight, about 65% by weight, about 70% by weight, about 75% by weight, about 80% by weight, about 85% by weight, about 90% by weight, about 95% by weight, or about 98% by weight. In some embodiments, the recyclable and biodegradable thermoplastic polymer is present in the formulation at a concentration of about 40% by weight. In some embodiments, the recyclable and biodegradable thermoplastic polymer is present in the formulation at a concentration of about 45% by weight. In some embodiments, the recyclable and biodegradable thermoplastic polymer is present in the formulation at a concentration of about 50% by weight. In some embodiments, the recyclable and biodegradable thermoplastic polymer is present in the formulation at a concentration of about 55% by weight. In some embodiments, the recyclable and biodegradable thermoplastic polymer is present in the formulation at a concentration of about 60% by weight. In some embodiments, the recyclable and biodegradable thermoplastic polymer is present in the formulation at a concentration of about 65% by weight. In some embodiments, the recyclable and biodegradable thermoplastic polymer is present in the formulation at a concentration of about 70% by weight. In some embodiments, the recyclable and biodegradable thermoplastic polymer is present in the formulation at a concentration of about 75% by weight. In some embodiments, the recyclable and biodegradable thermoplastic polymer is present in the formulation at a concentration of about 80% by weight. In some embodiments, the recyclable and biodegradable thermoplastic polymer is present in the formulation at a concentration of about 85% by weight. In some embodiments, the recyclable and biodegradable thermoplastic polymer is present in the formulation at a concentration of about 90% by weight. In some embodiments, the recyclable and biodegradable thermoplastic polymer is present in the formulation at a concentration of about 95% by weight. In some embodiments, the recyclable and biodegradable thermoplastic polymer is present in the formulation at a concentration of about 98% by weight.

In some embodiments, the recyclable and biodegradable filler is present in the formulation at a concentration of about 1% by weight to about 50% by weight. For example, in some embodiments, the recyclable and biodegradable filler is present in the formulation at a concentration of about 1% by weight, about 5% by weight, about 10% by weight, about 15% by weight, about 20% by weight, about 25% by weight, about 30% by weight, about 35% by weight, about 40% by weight, about 45% by weight, or about 50% by weight. In some embodiments, the recyclable and biodegradable filler is present in the formulation at a concentration of about 1% by weight. In some embodiments, the recyclable and biodegradable filler is present in the formulation at a concentration of about 5% by weight. In some embodiments, the recyclable and biodegradable filler is present in the formulation at a concentration of about 10% by weight. In some embodiments, the recyclable and biodegradable filler is present in the formulation at a concentration of about 15% by weight. In some embodiments, the recyclable and biodegradable filler is present in the formulation at a concentration of about 20% by weight. In some embodiments, the recyclable and biodegradable filler is present in the formulation at a concentration of about 25% by weight. In some embodiments, the recyclable and biodegradable filler is present in the formulation at a concentration of about 30% by weight. In some embodiments, the recyclable and biodegradable filler is present in the formulation at a concentration of about 35% by weight. In some embodiments, the recyclable and biodegradable filler is present in the formulation at a concentration of about 40% by weight. In some embodiments, the recyclable and biodegradable filler is present in the formulation at a concentration of about 45% by weight. In some embodiments, the recyclable and biodegradable filler is present in the formulation at a concentration of about 50% by weight. In some embodiments, the biodegradable filler is present in the formulation at a concentration of about 1% to about 10% by weight. In some embodiments, the recyclable and biodegradable filler is present in the formulation at a concentration of about 30% by weight to about 50% by weight.

In some embodiments, the halloysite is present in the formulation at a concentration of about 1% by weight to about 10% by weight. For example, in some embodiments, the halloysite is present in the formulation at a concentration of about 1% by weight, about 2% by weight, about 3% by weight, about 4% by weight, about 5% by weight, about 6% by weight, about 7% by weight, about 8% by weight, about 9% by weight, or about 10% by weight. In some embodiments, the halloysite is present in the formulation at a concentration of about 1% by weight. In some embodiments, the halloysite is present in the formulation at a concentration of about 2% by weight. In some embodiments, the halloysite is present in the formulation at a concentration of about 3% by weight. In some embodiments, the halloysite is present in the formulation at a concentration of about 4% by weight. In some embodiments, the halloysite is present in the formulation at a concentration of about 5% by weight. In some embodiments, the halloysite is present in the formulation at a concentration of about 6% by weight. In some embodiments, the halloysite is present in the formulation at a concentration of about 7% by weight. In some embodiments, the halloysite is present in the formulation at a concentration of about 8% by weight. In some embodiments, the halloysite is present in the formulation at a concentration of about 9% by weight. In some embodiments, the halloysite is present in the formulation at a concentration of about 10% by weight.

In some embodiments, the recyclable and biodegradable thermoplastic polymer of the formulation includes polylactic acid and an acrylic cross-linker. In some embodiments, the polylactic acid and acrylic cross-linker are present in the formulation at a ratio of about 99:1 to about 85:15. For example, in some embodiments, the polylactic acid and acrylic cross-linker are present in the formulation at a ratio of about 99:1, about 98:2, about 97:3, about 96:4, about 95:5, about 94:6, about 93:7, about 92:8, about 91:9, about 90:10, about 89:11, about 88:12, about 87:13, about 86:14, or about 85:15. In some embodiments, the polylactic acid and acrylic cross-linker are present in the formulation at a ratio of about 99:1. In some embodiments, the polylactic acid and acrylic cross-linker are present in the formulation at a ratio of about 98:2. In some embodiments, the polylactic acid and acrylic cross-linker are present in the formulation at a ratio of about 97:3. In some embodiments, the polylactic acid and acrylic cross-linker are present in the formulation at a ratio of about 96:4. In some embodiments, the polylactic acid and acrylic cross-linker are present in the formulation at a ratio of about 95:5. In some embodiments, the polylactic acid and acrylic cross-linker are present in the formulation at a ratio of about 94:6. In some embodiments, the polylactic acid and acrylic cross-linker are present in the formulation at a ratio of about 93:7. In some embodiments, the polylactic acid and acrylic cross-linker are present in the formulation at a ratio of about 92:8. In some embodiments, the polylactic acid and acrylic cross-linker are present in the formulation at a ratio of about 91:9. In some embodiments, the polylactic acid and acrylic cross-linker are present in the formulation at a ratio of about 90:10. In some embodiments, the polylactic acid and acrylic cross-linker are present in the formulation at a ratio of about 89:11. In some embodiments, the polylactic acid and acrylic cross-linker are present in the formulation at a ratio of about 88:12. In some embodiments, the polylactic acid and acrylic cross-linker are present in the formulation at a ratio of about 87:13. In some embodiments, the polylactic acid and acrylic cross-linker are present in the formulation at a ratio of about 86:14. In some embodiments, the polylactic acid and acrylic cross-linker are present in the formulation at a ratio of about 85:15.

In some embodiments, the recyclable and biodegradable thermoplastic polymer of the formulation includes cellulose acetate and a biocompatible plasticizer. In some embodiments, the biocompatible plasticizer is a biodegradable cross-linker.

In some embodiments, the recyclable and biodegradable thermoplastic polymer of the formulation includes one or more polyhydroxyalkanoates (PHA). In some embodiments, the recyclable and biodegradable thermoplastic polymer of the formulation includes calcium sulfate. In some embodiments, the recyclable and biodegradable thermoplastic polymer of the formulation includes boric acid. In some embodiments, the recyclable and biodegradable thermoplastic polymer of the formulation includes a combination of one or more polyhydroxyalkanoates, calcium sulfate, and boric acid.

In some embodiments, the recyclable and biodegradable thermoplastic polymer of the formulation includes polylactic acid and an acrylic cross-linker, cellulose acetate and a biocompatible plasticizer, one or more polyhydroxyalkanoates, calcium sulfate, boric acid, or any combination thereof.

In some embodiments, the recyclable and biodegradable filler of the formulation includes dried pulverized animal cartilage or chitosan, a non-cellulose additive and base material for biopolymers. In some embodiments, the dried pulverized animal cartilage is equine-derived, bovine-derived, porcine-derived, or any combination thereof. For example, in some embodiments, the dried pulverized animal cartilage is equine-derived. In some embodiments, the dried pulverized animal cartilage is bovine-derived. In some embodiments, the dried pulverized animal cartilage is porcine-derived.

In some embodiments, the dried pulverized animal cartilage has a particle size of about 50 um to 2 mm (i.e. 2000 μm). For example, in some embodiments, the dried pulverized animal cartilage has a particle size of about 50 μm, about 100 μm, about 150 μm, about 200 μm, about 250 μm, about 300 μm, about 350 μm, about 400 μm, 450 μm, about 500 μm, about 550 μm, about 600 μm, about 650 μm, about 700 μm, about 750 μm, about 800 μm, about 850 μm, about 900 μm, about 950 μm, about 1000 μm, about 1050 μm, about 1100 μm, about 1150 μm, about 1200 μm, about 1250 μm, about 1300 μm, about 1350 μm, about 1400 μm, about 1450 μm, about 1500 μm, about 1550 μm, about 1600 μm, about 1650 μm, about 1700 μm, about 1750 μm, about 1800 μm, about 1850 μm, about 1900 μm, about 1950 μm, or about 2000 μm. In some embodiments, the dried pulverized animal cartilage has a particle size of about 50 μm. In some embodiments, the dried pulverized animal cartilage has a particle size of about 100 μm. In some embodiments, the dried pulverized animal cartilage has a particle size of about 150 μm. In some embodiments, the dried pulverized animal cartilage has a particle size of about 200 μm. In some embodiments, the dried pulverized animal cartilage has a particle size of about 250 μm. In some embodiments, the dried pulverized animal cartilage has a particle size of about 300 μm. In some embodiments, the dried pulverized animal cartilage has a particle size of about 350 μm. In some embodiments, the dried pulverized animal cartilage has a particle size of about 400 μm. In some embodiments, the dried pulverized animal cartilage has a particle size of 450 μm. In some embodiments, the dried pulverized animal cartilage has a particle size of about 500 μm. In some embodiments, the dried pulverized animal cartilage has a particle size of about 550 μm. In some embodiments, the dried pulverized animal cartilage has a particle size of about 600 μm. In some embodiments, the dried pulverized animal cartilage has a particle size of about 650 μm. In some embodiments, the dried pulverized animal cartilage has a particle size of about 700 μm. In some embodiments, the dried pulverized animal cartilage has a particle size of about 750 μm. In some embodiments, the dried pulverized animal cartilage has a particle size of about 800 μm. In some embodiments, the dried pulverized animal cartilage has a particle size of about 850 μm. In some embodiments, the dried pulverized animal cartilage has a particle size of about 900 μm. In some embodiments, the dried pulverized animal cartilage has a particle size of about 950 μm. In some embodiments, the dried pulverized animal cartilage has a particle size of about 1000 μm. In some embodiments, the dried pulverized animal cartilage has a particle size of about 1050 μm. In some embodiments, the dried pulverized animal cartilage has a particle size of about 1100 μm. In some embodiments, the dried pulverized animal cartilage has a particle size of about 1150 μm. In some embodiments, the dried pulverized animal cartilage has a particle size of about 1200 μm. In some embodiments, the dried pulverized animal cartilage has a particle size of about 1250 μm. In some embodiments, the dried pulverized animal cartilage has a particle size of about 1300 μm. In some embodiments, the dried pulverized animal cartilage has a particle size of about 1350 μm. In some embodiments, the dried pulverized animal cartilage has a particle size of about 1400 μm. In some embodiments, the dried pulverized animal cartilage has a particle size of about 1450 μm. In some embodiments, the dried pulverized animal cartilage has a particle size of about 1500 μm. In some embodiments, the dried pulverized animal cartilage has a particle size of about 1550 μm. In some embodiments, the dried pulverized animal cartilage has a particle size of about 1600 μm. In some embodiments, the dried pulverized animal cartilage has a particle size of about 1650 μm. In some embodiments, the dried pulverized animal cartilage has a particle size of about 1700 μm. In some embodiments, the dried pulverized animal cartilage has a particle size of about 1750 μm. In some embodiments, the dried pulverized animal cartilage has a particle size of about 1800 μm. In some embodiments, the dried pulverized animal cartilage has a particle size of about 1850 μm. In some embodiments, the dried pulverized animal cartilage has a particle size of about 1900 μm. In some embodiments, the dried pulverized animal cartilage has a particle size of about 1950 μm. In some embodiments, the dried pulverized animal cartilage has a particle size of about 2000 μm.

In some embodiments, the recyclable and biodegradable filler of the formulation includes milk-whey-protein-derived polymer and chitosan, a non cellulose additive and base material for biopolymers. In some embodiments, the recyclable and biodegradable filler of the formulation includes milk-whey-protein-derived polymer. In some embodiments, the recyclable and biodegradable filler of the formulation includes chitosan.

In some embodiments, the recyclable and biodegradable filler of the formulation includes dried pulverized animal cartilage, milk-whey-protein-derived polymer, or a combination thereof.

In some embodiments, the recyclable and biodegradable plastic formulation of the disclosure also includes one or more micronutrients. For example, in some embodiments, the one more micronutrients includes lauryl phosphate. In some embodiments, the one or more micronutrients includes urea.

In some embodiments, the recyclable and biodegradable plastic formulation of the disclosure additionally includes a recyclable and biodegradable scent. Including a scent in the biodegradable and recyclable plastic formulation may make the resultant, cured material more attractive to a pet. For example, non-limiting examples of scents that may be included in recyclable and biodegradable plastic formulation of the disclosure include those that mimic chicken, beef, pork, peanut butter or a combination thereof. In addition to making the recyclable and biodegradable plastic more attractive to a pet, scents such as mint can be included, where the mint scent will help to improve the odor of a pet's breath. In some embodiments, the recyclable and biodegradable scent is hypoallergenic. In some embodiments, the recyclable and biodegradable scent is a liquid. In some embodiments, the recyclable and biodegradable scent is a terpene. In some embodiments, the terpene is a naturally-derived terpene. It should be appreciated that the term “naturally-derived” does not require that the terpene be literally extracted from a natural organism. Rather, the terpene may be synthetically produced using conventional means known to those of ordinary skill and it would qualify as “naturally-derived” so long as the compound is known to occur in or be derived from a natural organism.

In some embodiments, the recyclable and biodegradable scent of the formulation can also include a carrier. In some embodiments, the carrier is a biocompatible carrier. Such carriers are commonly known to those of ordinary skill in the art and would be readily identifiable without an undue burden of experimentation. In some embodiments, the carrier includes dispersed halloysite.

The recyclable and biodegradable thermoplastic formulation of the present disclosure can be used to prepare articles of manufacture using manufacturing methods and processes commonly known to those of ordinary skill in the art. For example, in some embodiments, the recyclable and biodegradable plastic formulation of the disclosure is compatible with injection molding.

The recyclable and biodegradable plastic formulation of the present disclosure demonstrates robust durability. For example, in some embodiments, the recyclable and biodegradable plastic formulation of the present disclosure demonstrates a wide range of Shore scale hardness values when measured via durometer. In some embodiments, the recyclable and biodegradable plastic formulation of the present disclosure demonstrates a Shore scale hardness value of 40 A to 78 D, when measured via durometer. In some embodiments, the recyclable and biodegradable plastic formulation of the present disclosure demonstrates a Shore scale hardness value of 40 A when measured via durometer. In some embodiments, the recyclable and biodegradable plastic formulation of the present disclosure demonstrates a Shore scale hardness value of 78 D when measured via durometer.

The Shore scale hardness value of a plastic material can be assessed by a skilled artisan using techniques commonly known in the art, for example, through the use of a durometer.

In some embodiments, the recyclable and biodegradable plastic formulations demonstrate high cold impact, high ductility, as well as high or low modulus of elasticity.

In some embodiments, the recycled and biodegradable plastic formulation of the disclosure is compostable under industrial conditions. For example, in some embodiments, the recyclable and biodegradable plastic formulation of the disclosure compostable at elevated temperatures and/or in the presence of forced air. In some embodiments, the elevated temperature is about 30° C. to about 100° C. In some embodiments, the elevated temperature is about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C. In some embodiments, the elevated temperature is about 30° C. In some embodiments, the elevated temperature is about 35° C. In some embodiments, the elevated temperature is about 40° C. In some embodiments, the elevated temperature is about 45° C. In some embodiments, the elevated temperature is about 50° C. In some embodiments, the elevated temperature is about 55° C. In some embodiments, the elevated temperature is about 60° C. In some embodiments, the elevated temperature is about 65° C. In some embodiments, the elevated temperature is about 70° C. In some embodiments, the elevated temperature is about 75° C. In some embodiments, the elevated temperature is about 80° C. In some embodiments, the elevated temperature is about 85° C. In some embodiments, the elevated temperature is about 90° C. In some embodiments, the elevated temperature is about 95° C. In some embodiments, the elevated temperature is about 100° C.

In some embodiments, the recyclable and biodegradable plastic formulation of the disclosure can be degraded and/or composted within a period of about 90 days. For example, in some embodiments, the recyclable and biodegradable plastic formulation can be degraded within a period of less than about 90 days, less than about 85 days, less than about 80 days, less than about 75 days, less than about 70 days, less than about 65 days, less than about 60 days, less than about 55 days, less than about 50 days. In some embodiments, the recyclable and biodegradable plastic formulation can be degraded within a period of less than about 90 days. In some embodiments, the recyclable and biodegradable plastic formulation can be degraded within a period of less than about 85 days. In some embodiments, the recyclable and biodegradable plastic formulation can be degraded within a period of less than about 80 days. In some embodiments, the recyclable and biodegradable plastic formulation can be degraded within a period of less than about 75 days. In some embodiments, the recyclable and biodegradable plastic formulation can be degraded within a period of less than about 70 days. In some embodiments, the recyclable and biodegradable plastic formulation can be degraded within a period of less than about 65 days. In some embodiments, the recyclable and biodegradable plastic formulation can be degraded within a period of less than about 60 days. In some embodiments, the recyclable and biodegradable plastic formulation can be degraded within a period of less than about 55 days. In some embodiments, the recyclable and biodegradable plastic formulation can be degraded within a period of less than about 50 days.

The present disclosure relates in a second aspect to a recyclable and biodegradable and/or compostable super chewer toy. It will be appreciated that the super chewer toy can be manufactured in many different shapes, sizes, colors, and textures. Each of these properties may be individually tuned or adjusted in order to make the super chewer toy appealing to pets of a plethora of species and sizes. Adapting a super chewer toy to a given species of pet is within the skill of one of ordinary skill in the art without an undue burden of experimentation.

In some embodiments, the super chewer toy is made of a plastic formulation of the disclosure, as described in the foregoing paragraphs. In some embodiments, a super chewer toy made of a plastic formulation of the disclosure is manufactured in the form of a dog bone. In some embodiments, a super chewer toy made of a plastic formulation of the disclosure is manufactured by injection molding, optionally in the form of a dog bone. In some embodiments, a super chewer toy made of a plastic formulation of the disclosure is manufactured in the form of a single-manufactured-layer (i.e. without multiple layers) dog bone.

In some embodiments, the present disclosure relates to a super chewer toy made of a single homogenous recyclable and biodegradable material, where the recyclable and biodegradable material is a thermoplastic and where the recyclable and biodegradable material is compatible with injection molding processes. In some embodiments, such a super chewer toy is in the form of a dog bone.

In some embodiments, the single homogenous recyclable and biodegradable material includes polylactic acid and an acrylic cross-linker. In some embodiments, the single homogenous recyclable and biodegradable material includes polylactic acid and an acrylic cross-linker at a ratio of about 99:1 to about 85:15. For example, in some embodiments, the polylactic acid and acrylic cross-linker are present in the single homogenous recyclable and biodegradable material at a ratio of about 99:1, about 98:2, about 97:3, about 96:4, about 95:5, about 94:6, about 93:7, about 92:8, about 91:9, about 90:10, about 89:11, about 88:12, about 87:13, about 86:14, or about 85:15. In some embodiments, the polylactic acid and acrylic cross-linker are present in the single homogenous recyclable and biodegradable material at a ratio of about 99:1. In some embodiments, the polylactic acid and acrylic cross-linker are present in the single homogenous recyclable and biodegradable material at a ratio of about 98:2. In some embodiments, the polylactic acid and acrylic cross-linker are present in the single homogenous recyclable and biodegradable material at a ratio of about 97:3. In some embodiments, the polylactic acid and acrylic cross-linker are present in the single homogenous recyclable and biodegradable material at a ratio of about 96:4. In some embodiments, the polylactic acid and acrylic cross-linker are present in the single homogenous recyclable and biodegradable material at a ratio of about 95:5. In some embodiments, the polylactic acid and acrylic cross-linker are present in the single homogenous recyclable and biodegradable material at a ratio of about 94:6. In some embodiments, the polylactic acid and acrylic cross-linker are present in the single homogenous recyclable and biodegradable material at a ratio of about 93:7. In some embodiments, the polylactic acid and acrylic cross-linker are present in the single homogenous recyclable and biodegradable material at a ratio of about 92:8. In some embodiments, the polylactic acid and acrylic cross-linker are present in the single homogenous recyclable and biodegradable material at a ratio of about 91:9. In some embodiments, the polylactic acid and acrylic cross-linker are present in the single homogenous recyclable and biodegradable material at a ratio of about 90:10. In some embodiments, the polylactic acid and acrylic cross-linker are present in the single homogenous recyclable and biodegradable material at a ratio of about 89:11. In some embodiments, the polylactic acid and acrylic cross-linker are present in the single homogenous recyclable and biodegradable material at a ratio of about 88:12. In some embodiments, the polylactic acid and acrylic cross-linker are present in the single homogenous recyclable and biodegradable material at a ratio of about 87:13. In some embodiments, the polylactic acid and acrylic cross-linker are present in the single homogenous recyclable and biodegradable material at a ratio of about 86:14. In some embodiments, the polylactic acid and acrylic cross-linker are present in the single homogenous recyclable and biodegradable material at a ratio of about 85:15.

In some embodiments, the single homogenous recyclable and biodegradable material includes cellulose acetate and a biocompatible plasticizer. In some embodiments, the recyclable and biocompatible plasticizer is a recyclable and biodegradable cross-linker.

In some embodiments, the single homogenous recyclable and biodegradable material includes a filler. In some embodiments, the filler is present in the single homogenous recyclable and biodegradable material at a concentration of about 1% by weight to about 50% by weight. For example, in some embodiments, the filler is present in the single homogenous recyclable and biodegradable material at a concentration of about 1% by weight, about 5% by weight, about 10% by weight, about 15% by weight, about 20% by weight, about 25% by weight, about 30% by weight, about 35% by weight, about 40% by weight, about 45% by weight, or about 50% by weight. In some embodiments, the filler is present in the single homogenous recyclable and biodegradable material at a concentration of about 1% by weight. In some embodiments, the filler is present in the single homogenous recyclable and biodegradable material at a concentration of about 5% by weight. In some embodiments, the filler is present in the single homogenous recyclable and biodegradable material at a concentration of about 10% by weight. In some embodiments, the filler is present in the single homogenous recyclable and biodegradable material at a concentration of about 15% by weight. In some embodiments, the filler is present in the single homogenous recyclable and biodegradable material at a concentration of about 20% by weight. In some embodiments, the filler is present in the single homogenous recyclable and biodegradable material at a concentration of about 25% by weight. In some embodiments, the filler is present in the single homogenous recyclable and biodegradable material at a concentration of about 30% by weight. In some embodiments, the filler is present in the single homogenous recyclable and biodegradable material at a concentration of about 35% by weight. In some embodiments, the filler is present in the single homogenous recyclable and biodegradable material at a concentration of about 40% by weight. In some embodiments, the filler is present in the single homogenous recyclable and biodegradable material at a concentration of about 45% by weight. In some embodiments, the filler is present in the single homogenous recyclable and biodegradable material at a concentration of about 50% by weight. In some embodiments, the filler is present in the single homogenous recyclable and biodegradable material at a concentration of about 1% to about 10% by weight. In some embodiments, the filler is present in the single homogenous recyclable and biodegradable material at a concentration of about 30% by weight to about 50% by weight.

In some embodiments, the filler of the single homogenous recyclable and biodegradable material includes dried pulverized animal cartilage. In some embodiments, the dried pulverized animal cartilage is equine-derived, bovine-derived, porcine-derived, or any combination thereof. For example, in some embodiments, the dried pulverized animal cartilage is equine-derived. In some embodiments, the dried pulverized animal cartilage is bovine-derived. In some embodiments, the dried pulverized animal cartilage is porcine-derived.

In some embodiments, the single homogenous recyclable and biodegradable material includes milk-whey-protein-derived polymer or chitosan, a non-cellulose additive and filler material for biopolymers. In some embodiments, the single homogenous recyclable and biodegradable material includes milk-whey-protein-derived polymer. In some embodiments, the single homogenous recyclable and biodegradable material includes chitosan.

In some embodiments, the single homogenous recyclable and biodegradable material includes halloysite. In some embodiments, the single homogenous recyclable and biodegradable material includes halloysite at a concentration of about 1% by weight to about 10% by weight. For example, in some embodiments, the halloysite is present in the formulation at a concentration of about 1% by weight, about 2% by weight, about 3% by weight, about 4% by weight, about 5% by weight, about 6% by weight, about 7% by weight, about 8% by weight, about 9% by weight, or about 10% by weight. In some embodiments, the halloysite is present in the formulation at a concentration of about 1% by weight. In some embodiments, the halloysite is present in the formulation at a concentration of about 2% by weight. In some embodiments, the halloysite is present in the formulation at a concentration of about 3% by weight. In some embodiments, the halloysite is present in the formulation at a concentration of about 4% by weight. In some embodiments, the halloysite is present in the formulation at a concentration of about 5% by weight. In some embodiments, the halloysite is present in the formulation at a concentration of about 6% by weight. In some embodiments, the halloysite is present in the formulation at a concentration of about 7% by weight. In some embodiments, the halloysite is present in the formulation at a concentration of about 8% by weight. In some embodiments, the halloysite is present in the formulation at a concentration of about 9% by weight. In some embodiments, the halloysite is present in the formulation at a concentration of about 10% by weight.

In some embodiments, the single homogenous recyclable and biodegradable material includes one or more polyhydroxyalkanoates (PHA). In some embodiments, the single homogenous recyclable and biodegradable material includes calcium sulfate. In some embodiments, the single homogenous recyclable and biodegradable material includes boric acid. In some embodiments, the single homogenous recyclable and biodegradable material includes polyhydroxyalkanoate, calcium sulfate, and boric acid.

In some embodiments, the single homogenous recyclable and biodegradable material includes one or more micronutrients. For example, in some embodiments, the one or more micronutrients includes lauryl phosphate. In some embodiments, the one or more micronutrients includes urea.

In some embodiments, the super chewer toy of the disclosure has a Shore scale hardness value of 40 A to 78 D. The Shore scale hardness value of a plastic material can be assessed by a skilled artisan using techniques commonly known in the art, for example, through the use of a durometer.

In some embodiments, the super chewer toy of the disclosure is composed of a recyclable and biodegradable plastic formulation that demonstrates high cold impact, high ductility, as well as high or low modulus of elasticity.

In some embodiments, the super chewer toy of the disclosure is compostable under industrial conditions. For example, in some embodiments, the super chewer toy is compostable at elevated temperatures and/or in the presence of forced air. In some embodiments, the elevated temperature is about 30° C. to about 100° C. In some embodiments, the elevated temperature is about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C. In some embodiments, the elevated temperature is about 30° C. In some embodiments, the elevated temperature is about 35° C. In some embodiments, the elevated temperature is about 40° C. In some embodiments, the elevated temperature is about 45° C. In some embodiments, the elevated temperature is about 50° C. In some embodiments, the elevated temperature is about 55° C. In some embodiments, the elevated temperature is about 60° C. In some embodiments, the elevated temperature is about 65° C. In some embodiments, the elevated temperature is about 70° C. In some embodiments, the elevated temperature is about 75° C. In some embodiments, the elevated temperature is about 80° C. In some embodiments, the elevated temperature is about 85° C. In some embodiments, the elevated temperature is about 90° C. In some embodiments, the elevated temperature is about 95° C. In some embodiments, the elevated temperature is about 100° C..

In some embodiments, the super chewer toy of the disclosure can be degraded and/or composted within a period of about 90 days. For example, in some embodiments, the super chewer toy can be degraded within a period of less than about 90 days, less than about 85 days, less than about 80 days, less than about 75 days, less than about 70 days, less than about 65 days, less than about 60 days, less than about 55 days, less than about 50 days. In some embodiments, the super chewer toy can be degraded within a period of less than about 90 days. In some embodiments, the super chewer toy can be degraded within a period of less than about 85 days. In some embodiments, the super chewer toy can be degraded within a period of less than about 80 days. In some embodiments, the super chewer toy can be degraded within a period of less than about 75 days. In some embodiments, the super chewer toy can be degraded within a period of less than about 70 days. In some embodiments, the super chewer toy can be degraded within a period of less than about 65 days. In some embodiments, the super chewer toy can be degraded within a period of less than about 60 days. In some embodiments, the super chewer toy can be degraded within a period of less than about 55 days. In some embodiments, the super chewer toy can be degraded within a period of less than about 50 days.

In some embodiments, the super chewer toy of the disclosure additionally includes a recyclable and biodegradable scent. Including a scent in the super chewer toy may make the product more attractive to a pet. For example, non-limiting examples of scents that may be included in the super chewer toy of the disclosure include those that mimic chicken, beef, pork, peanut butter, or a combination thereof. In addition to making the recyclable and biodegradable plastic more attractive to a pet, scents such as mint can be included, where the mint scent will help to improve the odor of a pet's breath. In some embodiments, the recyclable and biodegradable scent is a liquid. In some embodiments, the recyclable and biodegradable scent is a terpene. In some embodiments, the terpene is a naturally-derived terpene. It should be appreciated that the term “naturally-derived” does not require that the terpene be literally extracted from a natural organism. Rather, the terpene may be synthetically produced using conventional means known to those of ordinary skill and it would qualify as “naturally-derived” so long as the compound is known to occur in a natural organism. In some embodiments, the scents are compounded throughout the bone, rather than coated.

In some embodiments, the recyclable and biodegradable scent of the super chewer toy can also include a carrier. In some embodiments, the carrier is a recyclable and biocompatible carrier. Such carriers are commonly known to those of ordinary skill in the art and would be readily identifiable without an undue burden of experimentation. In some embodiments, the carrier includes dispersed halloysite. In some embodiments, the recyclable and biodegradable scent is adsorbed upon halloysite and added to the super chewer toy of the disclosure. In some embodiments, the recyclable and biodegradable scent is adsorbed upon halloy site and compounded throughout the super chewer toy of the disclosure.

In some embodiments, the super chewer toy includes a central cavity into which various additives can be placed. In certain embodiments, the central cavity is tubular in shape. In some embodiments, the tubular central cavity has a diameter of about 1% to about 10% the total diameter of the super chewer toy. In some embodiments, the tubular central cavity has a diameter of about 1% the total diameter of the super chewer toy. In some embodiments, the tubular central cavity has a diameter of about 2% the total diameter of the super chewer toy. In some embodiments, the tubular central cavity has a diameter of about 3% the total diameter of the super chewer toy. In some embodiments, the tubular central cavity has a diameter of about 4% the total diameter of the super chewer toy. In some embodiments, the tubular central cavity has a diameter of about 5% the total diameter of the super chewer toy. In some embodiments, the tubular central cavity has a diameter of about 6% the total diameter of the super chewer toy. In some embodiments, the tubular central cavity has a diameter of about 7% the total diameter of the super chewer toy. In some embodiments, the tubular central cavity has a diameter of about 8% the total diameter of the super chewer toy. In some embodiments, the tubular central cavity has a diameter of about 9% the total diameter of the super chewer toy. In some embodiments, the tubular central cavity has a diameter of about 10% the total diameter of the super chewer toy. In some embodiments, the recyclable and biodegradable scent is disposed within the central cavity.

The super chewer toy of the disclosure can be prepared via any appropriate manufacturing technique known to those of ordinary skill in the art. For example, in some embodiments, the super chewer toy of the disclosure is formed by injection molding the single homogenous recyclable and biodegradable material.

The present disclosure enables one of skill in the relevant art to make and use the inventions provided herein in accordance with multiple and varied embodiments. Various alterations, modifications, and improvements of the present disclosure that readily occur to those skilled in the art, including certain alterations, modifications, substitutions, and improvements are also part of this disclosure. Accordingly, the foregoing description are by way of example to illustrate the discoveries provided herein. Furthermore, the foregoing Description is exemplary of the present invention and not limiting thereof. The scope of the invention is therefore set out in the appended claims.

All patents and publications cited herein are fully incorporated by reference herein in their entirety.

Any composition disclosed herein may comprise, consist of, or consist essentially of any of the compounds or components disclosed herein. In accordance with the present disclosure, the phrases “consist essentially of,” “consists essentially of,” “consisting essentially of,” and the like limit the scope of a claim to the specified materials or steps and those materials or steps that do not materially affect the basic and novel characteristic(s) of the claimed invention.

As used herein, the term “about” refers to the cited value being within the errors arising from the standard deviation found in their respective testing measurements, and if those errors cannot be determined, then “about”refers to within 10% of the cited value.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

Unless expressly stated to the contrary, use of the term “a” is intended to include “at least one” or “one or more.” For example, “a compound” is intended to include “at least one compound” or “one or more compounds.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

### ENUMERATED EMBODIMENTS

Further embodiments of the disclosure are set out in the following enumerated clauses:
1. A biodegradable plastic formulation comprising:
   a biodegradable thermoplastic polymer;
   a biodegradable filler; and
   halloysite.
2. The biodegradable plastic formulation of clause 1, wherein the biodegradable thermoplastic polymer is present at a concentration of about 40% by weight to about 98% by weight.
3. The biodegradable plastic formulation of clause 1 or 2, wherein the biodegradable filler is present at a concentration of about 1% by weight to about 50% by weight.
4. The biodegradable plastic formulation of any one of clauses 1 to 3, wherein the biodegradable filler is present at a concentration of about 1% by weight to about 10% by weight.
5. The biodegradable plastic formulation of any one of clauses 1 to 3, wherein the biodegradable filler is present at a concentration of about 30% by weight to about 50% by weight.
6. The biodegradable plastic formulation of any one of clauses 1 to 3, wherein the halloysite is present at a concentration of about 1% by weight to about 10% by weight.
7. The biodegradable plastic formulation of any one of clauses 1 to 6, wherein the biodegradable thermoplastic polymer comprises polylactic acid and an acrylic cross-linker.
8. The biodegradable plastic formulation of any one of clauses 1 to 7, wherein the biodegradable thermoplastic polymer comprises polylactic acid and an acrylic cross-linker at a ratio of about 99:1 to about 85:15.
9. The biodegradable plastic formulation of any one of clauses 1 to 8, wherein the biodegradable thermoplastic polymer comprises cellulose acetate and a biocompatible plasticizer.
10. The biodegradable plastic formulation of clause 9, wherein the biocompatible plasticizer is a biodegradable cross-linker.
11. The biodegradable plastic formulation of any one of clauses 1 to 10, wherein the biodegradable thermoplastic polymer comprises a polyhydroxyalkanoate.
12. The biodegradable plastic formulation of any one of clauses 1 to 11, wherein the biodegradable thermoplastic polymer comprises calcium sulfate.
13. The biodegradable plastic formulation of any one of clauses 1 to 12, wherein the biodegradable thermoplastic polymer comprises boric acid.
14. The biodegradable plastic formulation of any one of clauses 1 to 10, wherein the biodegradable thermoplastic polymer comprises a polyhydroxyalkanoate, calcium sulfate, and boric acid.
15. The biodegradable plastic formulation of any one of clauses 1 to 14, wherein the biodegradable filler comprises dried pulverized animal cartilage.
16. The biodegradable plastic formulation of clause 15, wherein the dried pulverized animal cartilage is equine-derived, bovine-derived, or porcine-derived.
17. The biodegradable plastic formulation of clause 15 or 16, wherein the dried pulverized animal cartilage has a particle size of about 50 μm to about 2 mm.
18. The biodegradable plastic formulation of any one of clauses 1 to 17, wherein the filler comprises milk-whey-protein-derived polymer.
19. The biodegradable plastic formulation of any one of clauses 1 to 18, further comprising one or more micronutrients.
20. The biodegradable plastic formulation of clause 19, wherein the one or more micronutrients comprises lauryl phosphate.
21. The biodegradable plastic formulation of clause 19 or 20, wherein the one or more micronutrients comprises one or more amino acids.
22. The biodegradable plastic formulation of any one of clauses 1 to 25, further comprising a biodegradable scent.
23. The biodegradable plastic formulation of clause 22, wherein the biodegradable scent is a liquid.
24. The biodegradable plastic formulation of clause 22 or 23, wherein the biodegradable scent is a terpene.
25. The biodegradable plastic formulation of clause 24, wherein the terpene is naturally-derived.
26. The biodegradable plastic formulation of any one of clauses 23 to 25, wherein the biodegradable scent comprises a carrier.
27. The biodegradable plastic formulation of clause 26, wherein the carrier comprises dispersed halloy site.
28. The biodegradable plastic formulation of any one of clauses 23 to 25, wherein the biodegradable scent is adsorbed upon halloysite.
29. The biodegradable plastic formulation of any one of clauses 1 to 28, wherein the biodegradable plastic formulation is compatible with injection molding.
30. The biodegradable plastic formulation of any one of clauses 1 to 29, wherein the biodegradable plastic formulation has a Shore D scale hardness value of 67 D when cured.
31. The biodegradable plastic formulation of any one of clauses 1 to 30, wherein the biodegradable plastic formulation is compostable under industrial conditions, optionally wherein the biodegradable plastic formulation is compostable at elevated temperatures and/or in the presence of forced air.
32. The biodegradable plastic formulation of any one of clauses 1 to 31, wherein the biodegradable plastic material can be degraded and/or composted within a period of less than about 90 days.
33. An animal chew comprising the biodegradable plastic formulation of any one of clauses 1 to 32.
34. The animal chew of clause 33, wherein the animal chew is in the form of a dog bone.
35. The animal chew of clause 33 or 34, wherein the animal chew is formed by injection molding the biodegradable plastic formulation of any one of clauses 1 to 32.
36. An animal chew comprising a single homogenous biodegradable material, wherein the biodegradable material is a thermoplastic and wherein the biodegradable material is compatible with injection molding.
37. The animal chew of clause 36, wherein the animal chew is in the form of a dog bone.
38. The animal chew of clause 36 or 37, wherein the biodegradable material comprises polylactic acid and an acrylic cross-linker.
39. The animal chew of any one of clauses 36 to 38, wherein the biodegradable material comprises polylactic acid and an acrylic cross-linker at a ratio of about 99:1 to about 85:15.
40. The animal chew of any one of clauses 36 to 39, wherein the biodegradable material comprises cellulose acetate and a biocompatible plasticizer.
41. The animal chew of clause 40, wherein the biocompatible plasticizer is a biodegradable cross-linker.
42. The animal chew of any one of clauses 36 to 41, wherein the biodegradable material comprises a filler.
43. The animal chew of any one of clauses 36 to 42, wherein the biodegradable material comprises a filler at a concentration of about 1% by weight to about 50% weight.
44. The animal chew of any one of clauses 36 to 43, wherein the biodegradable material comprises a filler at a concentration of about 1% by weight to about 10% by weight.
45. The animal chew of any one of clauses 36 to 44, wherein the biodegradable material comprises a filler at a concentration of about 30% by weight to about 50% by weight.
46. The animal chew of any one of clauses 42 to 45, wherein the filler comprises dried pulverized animal cartilage.
47. The animal chew of clause 46, wherein the dried pulverized animal cartilage is equine-derived, bovine-derived, or porcine-derived.
48. The animal chew of clause 46 or 47, wherein the dried pulverized animal cartilage has a particle size of about 50 μm to about 2 mm.
49. The animal chew of any one of clauses 36 to 48, wherein the biodegradable plastic material comprises a milk-whey-protein-derived polymer.
50. The animal chew of any one of clauses 36 to 49, wherein the biodegradable plastic material comprises halloysite.
51. The animal chew of any one of clauses 36 to 50, wherein the biodegradable plastic material comprises halloysite at a concentration of about 1% by weight to about 10% by weight.
52. The animal chew of any one of clauses 36 to 51, wherein the biodegradable plastic material comprises a polyhydroxyalkanoate.
53. The animal chew of any one of clauses 36 to 52, wherein the biodegradable plastic material comprises calcium sulfate.
54. The animal chew of any one of clauses 36 to 53, wherein the biodegradable plastic material comprises boric acid.
55. The animal chew of any one of clauses 36 to 51, wherein the biodegradable plastic material comprises a polyhydroxyalkanoate, calcium sulfate, and boric acid.
56. The animal chew of any one of clauses 36 to 55, wherein the biodegradable plastic material comprises one or more micronutrients.
57. The animal chew of clause 56, wherein the one or more micronutrients comprises lauryl phosphate.
58. The animal chew of clause 56 or 57, wherein the one or more micronutrients comprise one or more amino acids.
59. The animal chew of any one of clauses 36 to 58, wherein the biodegradable plastic material has a Shore D scale hardness value of 67D.
60. The animal chew of any one of clauses 36 to 59, wherein the biodegradable plastic material is compostable under industrial conditions, optionally wherein the biodegradable plastic material is compostable at elevated temperatures and/or in the presence of forced air.
61. The animal chew of any one of clauses 36 to 60, wherein the biodegradable plastic material can be degraded and/or composted within a period of less than about 90 days.
62. The animal chew of any one of clauses 36 to 61, further comprising a biodegradable scent.
63. The animal chew of clause 62, wherein the biodegradable scent is a liquid.
64. The animal chew of clause 62 or 63, wherein the biodegradable scent is a terpene.
65. The animal chew of clause 64, wherein the terpene is naturally-derived.
66. The animal chew of any one of clauses 63 to 65, wherein the biodegradable scent comprises a carrier.
67. The animal chew of clause 66, wherein the carrier comprises dispersed halloysite.
68. The animal chew of any one of clauses 63 to 65, wherein the biodegradable scent is adsorbed upon halloy site.
69. The animal chew of any one of clauses 62 to 68, wherein the animal chew comprises a central cavity.
70. The animal chew of clause 69, wherein the central cavity is tubular in shape.
71. The animal chew of clause 70, wherein the central cavity has a diameter of about 1% to about 10% of a diameter of the animal chew.
72. The animal chew of any one of clauses 69 to 71, wherein the biodegradable scent is disposed within the central cavity.
73. The animal chew of any one of clauses 36 to 72, wherein the animal chew is formed by injection molding the single homogenous biodegradable material.

What is claimed is:

1. A recyclable and biodegradable plastic formulation comprising:
A recyclable and biodegradable thermoplastic polymer;
a recyclable and biodegradable filler; and
halloysite.

2. The recyclable and biodegradable plastic formulation of claim 1, wherein the recyclable and biodegradable thermoplastic polymer is present at a concentration of about 40% by weight to about 98% by weight.

3. The recyclable and biodegradable plastic formulation of claim 1, wherein the recyclable and biodegradable filler is present at a concentration of about 1% by weight to about 50% by weight.

4. The recyclable and biodegradable plastic formulation of claim 1, wherein the halloysite is present at a concentration of about 1% by weight to about 10% by weight.

5. The recyclable and biodegradable plastic formulation of claim 1, wherein the recyclable and biodegradable thermoplastic polymer comprises polylactic acid and an acrylic cross-linker.

6. The recyclable and biodegradable plastic formulation of claim 7, wherein the biodegradable thermoplastic polymer comprises polylactic acid and an acrylic cross-linker at a ratio of about 99:1 to about 85:15.

7. The recyclable and biodegradable plastic formulation of claim 1, wherein the recyclable and biodegradable thermoplastic polymer comprises cellulose acetate and a biocompatible plasticizer.

8. The recyclable and biodegradable plastic formulation of claim 7, wherein the biocompatible plasticizer is a recyclable and biodegradable cross-linker.

9. The recyclable and biodegradable plastic formulation of claim 1, wherein the biodegradable thermoplastic polymer comprises one or more polyhydroxyalkanoates.

10. The recyclable and biodegradable plastic formulation of claim 1, wherein the biodegradable thermoplastic polymer comprises calcium sulfate.

11. The recyclable and biodegradable plastic formulation of claim 1, wherein the biodegradable thermoplastic polymer comprises boric acid.

12. The recyclable and biodegradable plastic formulation of claim 1, wherein the recyclable and biodegradable filler comprises dried pulverized animal cartilage, chitosan, or a combination thereof.

13. The recyclable biodegradable plastic formulation of claim 12, wherein the dried pulverized animal cartilage has a particle size of about 50 μm to about 2 mm.

14. The recyclable and biodegradable plastic formulation of claim 1, wherein the recyclable and biodegradable filler comprises milk-whey-protein-derived polymer.

15. The recyclable and biodegradable plastic formulation of claim 1, further comprising one or more micronutrients.

16. The recyclable and biodegradable plastic formulation of claim 15, wherein the one or more micronutrients comprises lauryl phosphate, urea, or a combination thereof.

17. The recyclable and biodegradable plastic formulation of claim 1, further comprising a recyclable and biodegradable scent.

18. The recyclable and biodegradable plastic formulation of claim 17, wherein the biodegradable scent comprises a carrier.

19. The recyclable and biodegradable plastic formulation of claim 18, wherein the carrier comprises dispersed halloy site.

20. The recyclable and biodegradable plastic formulation of claim 19, wherein the biodegradable scent is adsorbed upon halloysite.

21. The recyclable and biodegradable plastic formulation of claim 1, wherein the biodegradable plastic formulation is compatible with injection molding.

22. A super chewer toy comprising the recyclable and biodegradable plastic formulation of claim 1.

23. The super chewer toy of claim 22, wherein the super chewer toy is in the form of a dog bone.

24. The super chewer toy of claim 22, wherein the super chewer toy is formed by injection molding the recyclable and biodegradable plastic formulation of claim 1.

25. A super chewer toy comprising a single homogenous recyclable and biodegradable material, wherein the recyclable and biodegradable material is a thermoplastic and wherein the recyclable and biodegradable material is compatible with injection molding.

26. The super chewer toy of claim 25, wherein the super chewer toy is in the form of a dog bone.

27. The super chewer toy of claim 25, wherein the recyclable and biodegradable material comprises polylactic acid and an acrylic cross-linker.

28. The super chewer toy of claim 27, wherein the recyclable and biodegradable material comprises polylactic acid and an acrylic cross-linker at a ratio of about 99:1 to about 85:15.

29. The super chewer toy of claim 25, wherein the recyclable and biodegradable material comprises cellulose acetate and a biocompatible plasticizer.

30. The super chewer toy of claim 25, wherein the recyclable and biodegradable material comprises a recyclable and biodegradable filler.

31. The super chewer toy of claim 30, wherein the recyclable and biodegradable material comprises a recyclable and biodegradable filler at a concentration of about 1% by weight to about 50% weight.

32. The super chewer toy of claim 30, wherein the recyclable and biodegradable filler comprises dried pulverized animal cartilage, chitosan, or a combination thereof.

33. The super chewer toy of claim 32, wherein the dried pulverized animal cartilage has a particle size of about 50 μm to about 2 mm.

34. The super chewer toy of claim 25, wherein the recyclable and biodegradable plastic material comprises a milk-whey-protein-derived polymer.

35. The super chewer toy of claim 25, wherein the recyclable and biodegradable plastic material comprises halloysite.

36. The super chewer toy of claim 35, wherein the recyclable and biodegradable plastic material comprises halloysite at a concentration of about 1% by weight to about 10% by weight.

37. The super chewer toy of claim 25, wherein the recyclable and biodegradable plastic material comprises one or more polyhydroxyalkanoates.

38. The super chewer toy of claim 25, wherein the recyclable and biodegradable plastic material comprises calcium sulfate.

39. The super chewer toy of claim 25, wherein the recyclable and biodegradable plastic material comprises boric acid.

40. The super chewer toy of claim 25, wherein the recyclable and biodegradable plastic material comprises one or more micronutrients.

41. The super chewer toy of claim 40, wherein the one or more micronutrients comprises lauryl phosphate, urea, or a combination thereof.

42. The super chewer toy of claim 25, further comprising a recyclable and biodegradable scent.

43. The super chewer toy of claim 42, wherein the recyclable and biodegradable scent comprises a carrier.

44. The super chewer toy of claim 43, wherein the carrier comprises dispersed halloysite.

45. The super chewer toy of claim 44, wherein the recyclable and biodegradable scent is adsorbed upon the halloysite.

46. The super chewer toy of claim 25, wherein the super chewer toy comprises a central cavity.

47. The super chewer toy of claim 46, wherein a recyclable and biodegradable scent is evenly dispersed within the central cavity.

48. The super chewer toy of claim 25, wherein the animal chew is formed by injection molding the single homogenous recyclable and biodegradable material.

49. The super chewer toy of claim 25, wherein the super chewer toy in the form of a single-manufactured-layer dog bone.
